(19) United States
(12) Patent Application Publication
(10) Pub. No.: US 2015/0219132 A1
(43) Pub. Date: Aug. 6, 2015

(54) RETAINING CLIP FOR AT LEAST ONE ELONGATE ELEMENT

(71) Applicant: GM GLOBAL TECHNOLOGY OPERATIONS LLC, Detroit, MI (US)

(72) Inventor: Joachim LACROIX, Flonheim (DE)

(21) Appl. No.: 14/610,958

(22) Filed: Jan. 30, 2015

(30) Foreign Application Priority Data
Feb. 1, 2014 (DE) 10 2014 001 382.0

(51) Int. Cl. F16B 2/22

(52) U.S. Cl. CPC F16B 2/22

(57) ABSTRACT

A retaining clip for at least one elongate element for encompassing the at least one elongate element is disclosed. The retaining clip includes an outer component and an inner component. The inner component is arranged on an inner side of the outer component and connected thereto in a firmly bonded fashion. The outer component features a retraction space for the inner component on its inner side.

### CROSS REFERENCE TO RELATED APPLICATION

This application claims priority to German Patent Application No. 102014001382.0 filed Feb. 1, 2014, which is incorporated herein by reference in its entirety.

### TECHNICAL FIELD

The present disclosure pertains to a retaining clip for at least one elongate element.

### BACKGROUND

Retaining clips are typically used for bundling and/or holding lines, cables and/or tubes. They are frequently realized in the form of ring segments and clipped around one or more lines, cables and/or tubes. Retaining clips are frequently made of an elastic plastic material. There already exist retaining clips that are composed of two components, particularly an outer and an inner component, wherein the inner component consists of a soft elastic material.

For example, publication UK 1 328 792 describes a clip with an outer and an inner section, wherein the inner section is made of an elastic material. The inner section is pressed against a line arranged in the retaining clip by the outer section such that the inner section is compressed against the outer section. In addition, other objects, desirable features and characteristics will become apparent from the subsequent summary and detailed description, and the appended claims, taken in conjunction with the accompanying drawings and this background.

### SUMMARY

The present disclosure makes available a functionally improved retaining clip. A retaining clip for at least one elongate element is proposed. The elongate element is realized, for example, in the form of at least one line, in the form of at least one cable and/or in the form of at least one tube. The retaining clip is designed for encompassing and/or holding the at least one elongate element, in particular radially. In this way, several elongate elements can be bundled and held together. The retaining clip is preferably designed for fastening the at least one elongate element on an adjacent construction. It is particularly preferred that the retaining clip comprises a mechanical interface for being connected to the adjacent construction, as well as a receptacle for a fastening means such as a screw or a plug-in section to be inserted into the adjacent construction.

The retaining clip is preferably realized as a ring segment or in the form of a ring segment. The ring segment encloses a receptacle for the at least one elongate element. The retaining clip is particularly realized in the form of a circular ring with an opening in the circumferential direction, wherein the opening interrupts the circular ring. The at least one elongate element preferably can be inserted through the opening in order to be arranged in the receptacle. The receptacle is designed, in particular, for accommodating the at least one elongate element therein.

The retaining clip, particularly the ring segment and/or the opened circular ring, comprises an outer component and an inner component. The outer component preferably forms an outer edge section of the retaining clip that is spaced apart from the receptacle. The inner component is arranged, in particular, between the receptacle and the outer component, wherein the outer component encloses the inner component. The inner component is optionally arranged directly adjacent to and encloses the receptacle in the form of a ring segment. The inner component is arranged on an inner side of the outer component. It is connected to the outer component in a firmly bonded fashion. The outer component especially has a larger inside diameter than the inner component.

The outer component features a retraction space for the inner component. The retraction space is arranged on the inner side of the outer component. In the context of the present invention, the term “retraction space” refers to a region on the inner circumference of the outer component that is designed for accommodating at least part of the inner component. When pressure is exerted in the direction of the outer component, the inner component is preferably pushed back and/or pressed into the retraction space. The pressure upon the inner component may be generated, e.g., by the elongate element that is arranged and/or can be arranged in the receptacle.

It is advantageous that the inner component can be pressed into the retraction space when it encompasses the at least one elongate element. Since the inner component is pressed and/or retracted into the retraction space, the diameter of the receptacle can be increased in accordance with the respective requirements due to an elasticity and/or compressibility of the inner component and/or due to a pre-stress of the retaining clip. In this way, the retaining clip can advantageously adapt itself to different diameters of the at least one elongate element. Consequently, the number of retaining clips with different diameters can be reduced. The retaining clip particularly can be flexibly utilized in several applications.

In a preferred embodiment, the retraction space is realized in the form of a groove. The groove is preferably produced in the inner side of the outer component. In this respect, it is particularly preferred that the retraction space is realized without interruptions and/or continuously in the circumferential direction of the retaining clip. The retraction space particularly is realized in the form of a ring segment in the circumferential direction.

In an alternative embodiment, the retraction space also may only be produced sectionally in the inner side of the outer component. In this case, the retraction space particularly features interruptions in the circumferential direction and/or does not extend continuously on the inner side of the outer component. For example, the retraction space and, in particular, the inner component arranged therein are realized in the form of several spaced-apart ring segments. According to the invention, even a punctiform and/or guttate design and/or arrangement of the receptacle space and, in particular, the inner component arranged therein would be possible on the inner side of the outer component.

According to a potential constructive design of the invention, the outer component is realized in the form of a circular ring with an opening in the circumferential direction, wherein the opening interrupts the circular ring. The outer component is preferably realized in the form of a ring segment.

In a preferred implementation, the outer component comprises two end sections that end in the opening. It is particularly preferred that the end sections protrude from the opening radially outward, e.g. obliquely toward the outside of the receptacle. The end sections particularly form insertion bevels for the at least one elongate element and/or a positioning aid for the retaining clip. It is advantageous that the at least one elongate element can be easily and quickly inserted into the receptacle of the retaining clip due to the insertion bevels. It is optionally also advantageous that the retaining clip can be easily and quickly positioned in installation positions that are difficult to access and/or not clearly visible.

In an alternative implementation, it is also possible that the retaining clip is placed around the at least one elongate element in the opened state. In this case, the end sections remain spaced apart from one another and mutually untensioned.

It would be conceivable that the retaining clip features a hinge, by means of which the opening can be radially enlarged. In this way, the insertion of the elongate element through the opening and its placement into the receptacle can be simplified. It would alternatively also be possible that the retaining clip is realized in one piece and/or without a hinge, wherein the retaining clip has an inherent elasticity that allows the insertion of the elongate element through the opening and its placement into the receptacle. This has the advantage that the retaining clip can be easily and inexpensively manufactured.

Each end section optionally features a hole for inserting a tensioning device such as, e.g., a screw and a nut. The end sections particularly can be brought together and/or mutually tensioned when the tensioning device is tightened. In this way, the opening of the annular retaining clip is closed. Optionally, the at least one elongate element may initially be arranged in the receptacle with certain play. The diameter of the receptacle is preferably reduced by bringing together and/or mutually tensioning the end sections such that the at least one elongate element arranged in the receptacle is pressed against the inner component and the inner component is thereby compressed and pushed in the direction of the retraction space.

In a potential constructive implementation, the outer component comprises a hard plastic material, particularly a thermoplastic plastic material, or is made thereof. For example, the outer component comprises polyamide or is made thereof The outer component is optionally also realized such that it can be bent to a limited degree, is flexible and/or resilient. For example, the outer component can be bent apart to a certain degree at the end sections and/or in the region of the opening due to its limited bendability, flexibility and/or resilient properties such that the opening can be enlarged in order to insert the at least one elongate element and the insertion is simplified.

For example, the inner component is made of a soft compressible material. An original overall height and/or an original volume of the inner component particularly is reduced while its density is simultaneously increased, e.g., when pressure is exerted thereupon due to the insertion of the at least one elongate element into the receptacle. The inner component once again expands when the pressure is relieved, particularly when the receptacle is no longer fitted with the elongate element, such that the density of the inner component decreases and its volume simultaneously increases and/or it reassumes the original overall height. For example, the inner component is made of an elastomer, particularly of an open-pored material such as, e.g., cellular material or rubber.

In a particularly preferred embodiment of the invention, the retaining clip can be manufactured in a plastic injection-molding process. In this case, the inner component and the outer component are produced by means of injection-molding. The inner component is preferably injected into the retraction space. The injection of the inner component into the retraction space preferably takes place in the same production step as the molding process, particularly by utilizing a two-component mold.

In a preferred embodiment, the inner component can assume an uncompressed state, a partially compressed state and a completely compressed state. In the uncompressed state, the inner component preferably protrudes from the retraction space and has an original overall height. For example, two-thirds of the original overall height protrudes from the retraction space in the uncompressed state, wherein one-third of the overall height is arranged in the retraction space and connected to the outer component in a firmly bonded fashion at this location.

According to a preferred embodiment, the inner component protrudes from the retraction space by at least ten percent, preferably by at least 15 percent, particularly by at least 20 percent, of the inside diameter of the outer component in the uncompressed state. The inner component alternatively or optionally protrudes from the retraction space by no more than 35 percent of the inside diameter of the outer component in the uncompressed state.

In a preferred implementation, the inner component can be compressed in the direction of the retraction space by at least one-third, preferably by at least half, particularly by at least two-thirds, of its original overall height in the uncompressed state. The inner component can alternatively or optionally be compressed in the direction of the retraction space by no more than three-quarters of its original overall height.

According to a preferred embodiment, the inner component can be compressed in the direction of the retraction space by at least ten percent, preferably by at least 15 percent, particularly by at least 20 percent, of the inside diameter of the outer component in the uncompressed state. The inner component can alternatively or optionally be compressed in the direction of the retraction space by no more than 35 percent of the inside diameter of the outer component in the uncompressed state.

The inner component optionally is partially pressed into the retraction space in the partially compressed state. For example, the inner component is pressed in the direction of the retraction space by at least one-third, preferably by at least half and/or by no more than two-thirds, of its original overall height. The inner component alternatively or optionally can be compressed in the direction of the retraction space by at least ten percent, preferably by at least 15 percent and/or by no more than 25 percent, of the inside diameter of the outer component in the partially compressed state.

The inner component may be completely compressed and/or completely arranged in the retraction space in the completely compressed state. In this case, the inner component preferably ends flush with the inner side of the outer component. A diameter of the receptacle corresponds to the inside diameter of the outer component in this case. The original overall height of the inner component may be reduced by up to three-quarters due to the complete compression. The original overall height of the inner component optionally corresponds to a depth of the receptacle space in the completely compressed state.

Due to the compressibility of the inner component, the diameter of the receptacle of the retaining clip can be advantageously adapted to the diameter of the at least one elongate element that is arranged and/or can be arranged in the receptacle. The elongate element particularly can be arranged in the receptacle with an interference fit.

In a preferred embodiment, the retaining clip is designed for mounting at least one brake line and/or fuel line of a motor vehicle, particularly of a passenger car or truck. The retaining clip particularly is designed for bundling and/or holding together several brake lines and/or fuel lines. The at least one brake line and/or fuel line optionally can be fastened on the adjacent construction by means of the retaining clip.

Noise development and/or rattling of the at least one elongate element within the retaining clip and/or relative to the adjacent construction can be advantageously prevented due to the fact that the inner component is preferably made of a compressible soft material. The support on the soft material is particularly advantageous with respect to brake lines and/or fuel lines that are usually made of metal or hard plastic material and therefore have a tendency to generate undesirable noises while the vehicle is in motion. The inner component of soft material particularly absorbs vibrations generated due to the motion of the vehicle and, if applicable, noises caused by these vibrations.

### BRIEF DESCRIPTION OF THE DRAWINGS

The present invention will hereinafter be described in conjunction with the following drawing figures, wherein like numerals denote like elements, and:

FIG. 1 shows a top view of a retaining clip with an outer component and an inner component;

FIG. 2 shows a top view of an opening of the retaining clip, in which the inner component assumes an uncompressed state;

FIG. 3 shows a top view of an opening of the retaining clip, in which the inner component assumes a partially compressed state; and

FIG. 4 shows a top view of an opening of the retaining clip, in which the inner component assumes a completely compressed state.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

Corresponding or identical components are respectively identified by the same reference symbols in the figures.

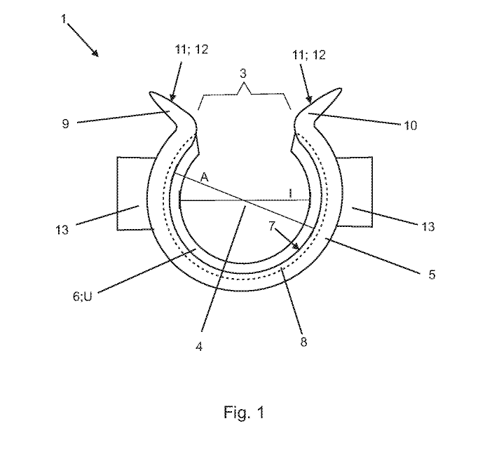

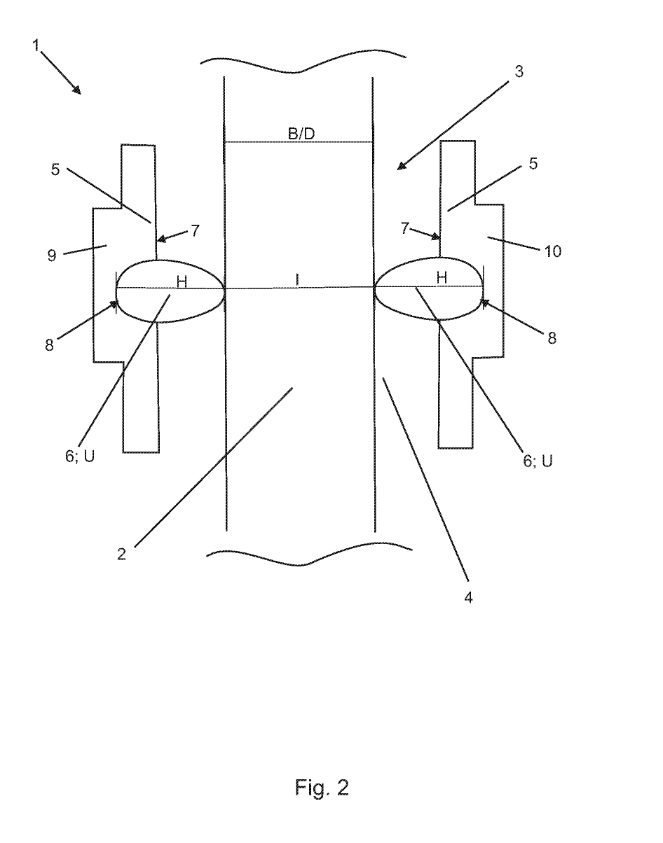

FIG. 1 shows a top view of a retaining clip 1. The retaining clip 1 is designed for holding at least one elongate element 2 (FIGS. 2 to 4) and/or for bundling several elongate elements 2. The retaining clip 1 is also designed for fastening the at least one elongate element 2 on an adjacent construction. The at least one elongate element 2 is realized, e.g., in the form of at least one line, cable and/or tube, particularly in the form of at least one fuel line and/or brake line.

The retaining clip 1 is realized in the form of a ring section. It is realized in the form of a circular ring with an opening 3 and features a receptacle 4 for the elongate element 2. The elongate element 2 can be inserted into the receptacle 4 through the opening 3, wherein the elongate element is radially encompassed by the retaining clip 1 once it is inserted into the receptacle 4.

The retaining clip 1 comprises an outer component 5 with an inside diameter A and an inner component 6 with an inside diameter I. Both components 5, 6 are realized in the form of a ring section and/or in the form of a circular ring with the opening 3. The outer component 5 encloses the inner component 6, wherein this inner component is arranged on an inner side 7 of the outer component 5. The inner component 6 particularly is arranged between the receptacle 4 and the outer component 5.

The outer component 5 features two end sections 9, 10. The end sections 9; 10 protrude obliquely outward from the opening 3. They end in the opening 3 and form an insertion bevel 11, by means of which the at least one elongate element 2 can be easily and quickly inserted into the receptacle 4 through the opening 3. In addition, the end sections 9, 10 form a positioning aid 12 for the retaining clip 1. In this way, the retaining clip 1 can also be easily positioned in poorly visible installation positions.

In an alternative exemplary embodiment, each end section 9, 10 may feature a hole, into which a tensioning device such as, e.g., a screw and a nut can be inserted. The end sections 9, 10 can be brought together and/or mutually tensioned by tightening the tensioning device such that the opening 3 of the retaining clip 1 is closed. The diameter of the receptacle particularly is reduced by bringing together and/or mutually tensioning the end sections 9, 10 such that the elongate element 2 arranged in the receptacle 4 (FIG. 2) presses against the inner component 6 and the inner component is thereby pushed into the retraction space 8.

In order to be fastened on the adjacent construction, the retaining clip 1 features two fastening interfaces 13 that are oppositely arranged laterally on the outer component 6.

The outer component 5 is made of a thermoplastic plastic material such as, e.g., polyamide. It is realized such that it can be bent to a limited degree and/or is flexible. It particularly has resilient properties. In this way, the end sections 9; 10 can be bent apart during the insertion of the at least one elongate element 2 such that the opening 3 is temporarily enlarged and the elongate element 2 can be inserted even easier.

The outer component 5 features a receptacle space 8 for the inner component 6 on its inner side 7. The receptacle space 8 is realized in the form of a groove that extends continuously and without interruptions along the inner side 7. In an alternative exemplary embodiment, the receptacle space 8 may also be composed of several receptacle space sections that extend along the inner side 7 and are spaced apart from one another.

The inner component 6 is at least partially and/or sectionally arranged in the receptacle space 8 and fastened therein in a firmly bonded fashion. It protrudes from the receptacle space 8 by at least one-third, preferably by at least half, particularly by at least two-thirds, of its overall height H and/or by no more than three-quarters of its overall height H.

The retaining clip 1 in the form of a plastic part is manufactured in a plastic injection-molding process. The receptacle space 8 is a molded into the outer component 5 during the injection-molding process. The inner component 6 is injected into the receptacle space 8 in the same production step, particularly by utilizing a two-component mold.

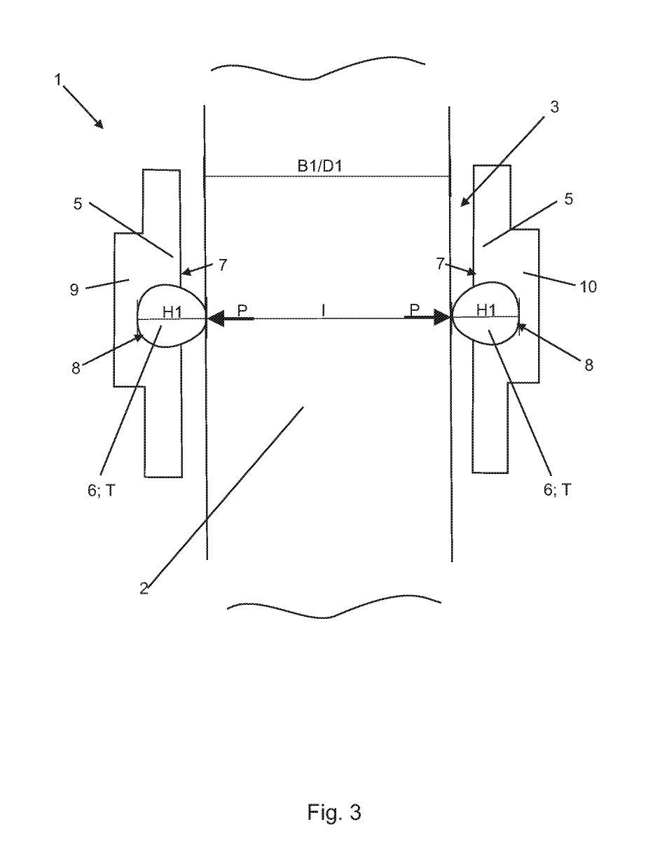

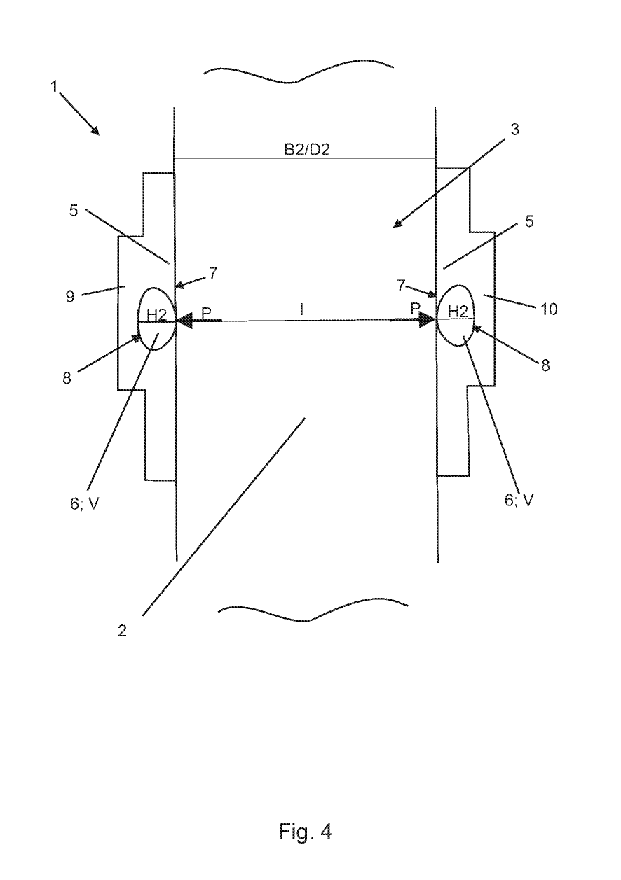

The inner component is made of a soft compressible material such as, e.g., rubber. If a pressure p is exerted upon the inner component 6, e.g., by the elongate element 2 inserted into the receptacle 4 with an interference fit, the original height H and the volume of the inner component 6 are reduced while its density simultaneously increases. In this case, the inner component 6 assumes a partially compressed state T (FIG. 3) or a completely compressed state V (FIG. 4). Once no pressure p is any longer exerted upon the inner component 6, which is the case, in particular, when the elongate element 2 is removed from the receptacle 4, the inner component 6 reassumes its original height H, its original volume and its original density. The component is then in an uncompressed state U as illustrated in FIG. 1. In the uncompressed state U, the inner component 6 protrudes from the retraction space 8 by at least 10 percent, preferably by at least 15 percent, particularly by at least 20 percent and/or by no more than 35 percent of the inside diameter A of the outer component 5.

Since the inner component 6 is made of soft compressible material, it can adapt itself to a thickness D, D1, D2 or a diameter D, D1, D2 of the elongate element 2. Furthermore, the soft compressible material absorbs vibrations and/or shocks of the elongate element itself and/or relative to the adjacent construction such as, e.g., the motor vehicle. Undesirable noise development such as, e.g., rattling particularly can be dampened or prevented.

FIG. 2 shows the retaining clip 1 from above in the form of a top view of the opening 3. The elongate element 2 is inserted into the receptacle 4 in a precisely fitted fashion. In this context, precisely fitted means that the inside diameter I of the inner component 6 corresponds to a width B and/or a diameter D of the elongate element 2.

The inner component 6 adjoins the outer side of the elongate element 2 and encompasses the elongate element without exerting pressure on one another. The inner component 6 particularly is not subjected to any pressure and assumes the uncompressed state U. In the uncompressed state U, the inner component 6 protrudes from the retraction space 8 and has its original overall height H. It is not pressed into the retraction space 8, namely not even partially. Due to the contact of the inner component 6 with the elongate element 2, said element is securely held in the retaining clip 1, bundled and/or can be fastened on the adjacent construction.

FIG. 3 shows the retaining clip 1 according to FIG. 2, wherein the elongate element 2 inserted into the receptacle 4 has a greater width B1 and/or a greater diameter D1 than in FIG. 2. The width B1 and/or the diameter D1 of the elongate element 2 particularly is greater than the inside diameter I of the inner component 6 in the uncompressed state U according to FIGS. 1 and 2.

Due to the slight oversize, the elongate element 2 is inserted into the receptacle 4 of the retaining clip 1 with a slight interference fit and securely held therein, bundled and/or can be fastened on the adjacent construction.

The slight oversize causes the elongate element 2 to exert pressure p upon the inner component 6. Due to the pressure p, this inner component is partially pressed into the receptacle space 8 and in the partially compressed state T. It is compressed in the direction of the retraction space 8 by at least 10 percent, preferably by at least 15 percent, particularly by at least 20 percent and/or by no more than 25 percent, of the inside diameter A of the outer component 5 (FIG. 1). Consequently, the original overall height H of the inner component 6 is reduced to a smaller overall height H1. In this case, the original overall height H is reduced by at least one-third, preferably by at least half and/or by no more than two-thirds.

FIG. 4 shows the retaining clip 1 according to FIG. 3, wherein the elongate element 2 inserted into the receptacle 4 has an even greater width B2 and/or an even greater diameter D2 than the elongate element 1 illustrated in FIG. 3.

The width B2 and/or the diameter D2 of the elongate element 2 according to FIG. 4 is significantly larger than the inside diameter I of the inner component 6 in the uncompressed state U (FIGS. 1 and 2). The width B2 and/or the diameter D2 of the elongate element 2 particularly corresponds to the inside diameter A of the outer component 5 or is even greater than the inside diameter A.

The elongate element 2 is inserted into the receptacle 4 of the retaining clip 1 with an interference fit relative to the inner component 6 such that it is securely held in the retaining clip 1, bundled and/or can be fastened on the adjacent construction.

The elongate element 2 exerts significant pressure p upon the inner component 6. Consequently, the inner component 6 is completely pressed into the receptacle space 8 and in the completely compressed state V. The original overall height H of the inner component 6 (FIG. 2) is reduced to a significantly smaller overall height H2 in the completely compressed state V. The original overall height H is optionally reduced by three-quarters. According to FIG. 4, the overall height H2 corresponds to an overall depth G of the receptacle space 8.

In conclusion, it should be noted that the retaining clip 1 is due to the compressibility of the inner component 6 designed for accommodating various elongate elements 2 with different widths B, B1, B2 and/or diameters D, D1, D2 in the receptacle 4. The retaining clip 1 particularly can be flexibly utilized in different applications. In this way, the number of retaining clips 1 with differently sized receptacles 4 can be reduced.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-17. (canceled)

18. A supporting collar for an elongate member comprising:
an outer component having a retraction space formed in an inner side; and
an inner component arranged on the inner side of the outer component and firmly bonded thereto;
wherein the supporting collar is configured to encompass the elongate member.

19. The supporting collar according to claim 18, wherein the retraction space comprises a groove formed in the inner side of the outer component.

20. The supporting collar according to claim 19, wherein the groove is formed continuously in a circumferential direction on the inner side of the outer component.

21. The supporting collar according to claim 18, wherein the retraction space is formed continuously in a circumferential direction on the inner side of the outer component.

22. The supporting collar according to claim 18, wherein the outer component comprises a circular ring with an opening formed in the circumferential direction thereof, wherein the opening interrupts the circular ring.

23. The supporting collar according to claim 22, wherein the outer component further comprises two end sections protruding radially outward from the opening.

24. The supporting collar according to claim 23, wherein the end sections form an insertion bevel for the elongate member.

25. The support collar according to claim 23 wherein the end sections form a positioning aid for the supporting collar.

26. The supporting collar according to claim 18, wherein the outer component comprises a thermoplastic plastic component.

27. The supporting collar according to claim 18, wherein the inner component comprises an injected component in the retraction space of the outer component.

28. The supporting collar according to claim 18, wherein the inner component comprises a soft compressible component relative to the outer component.

29. The supporting collar according to claim 18, the inner component comprising a component formable in at least three states;
wherein the inner component protrudes from the retraction space and has an original overall height in a first, uncompressed state;
wherein the inner component is partially pressed into the retraction space in a second, partially-compressed state; and
wherein the inner component is completely arranged in the retraction space in a third, completely-compressed state.

30. The supporting collar according to claim 29, wherein the inner component is compressible in the direction of the retraction space by at least one-third of an original overall height in the first, uncompressed state and no more than three-quarters, of the original overall height in the uncompressed state.

31. The supporting collar according to claim 30, wherein the inner component protrudes from the retraction space by at least 10 percent and no more than 35 percent, of an inside diameter of the outer component in the uncompressed state.

32. The supporting collar according to claim 29, wherein the inner component can be compressed in the direction of the retraction space by at least 10 percent and by no more than 35 percent, of an inside diameter of the outer component in the uncompressed state.

33. The supporting collar according to claim 18, wherein the compressibility of the inner component is configured to adapt to different widths and/or diameters of the elongate member when encompassed within the supporting collar.

34. The supporting collar according to claim 18 configured to hold, bundle and fasten at least one of a brake line and a fuel line of a motor vehicle.

35. An arrangement comprising at least one elongate member encompassed by the supporting collar according to claim 18.
